(19) United States
(12) Patent Application Publication
(10) Pub. No.: US 2005/0080744 A1
(43) Pub. Date: Apr. 14, 2005

(54) Content management system in web link

(76) Inventor: Yoshiki Ashida, Shibuya-ku Tokyo (JP)

Correspondence Address: DARBY & DARBY P.C., P. O. BOX 5257, NEW YORK, NY, 10150-5257, US

(21) Appl. No.: 10/503,576

(22) PCT Filed: Feb. 3, 2003
(86) PCT No.: PCT/JP03/01053

(30) Foreign Application Priority Data
Feb. 4, 2002 (JP) 2002-27109

(51) Int. Cl. G06F 17/60; H04K 1/00; H04L 9/00

(52) U.S. Cl. 705/51; 705/52

(57) ABSTRACT

A content management system, wherein a series of websites connected via links is formed and whereby the revenue which the whole of the websites earned viewing fee, advertisement income etc. as sources are properly distributed to masters of the websites according to their respective rating of contribution calculated by the number of viewers etc. to their websites. The websites employ re-encryption technology. A founder who establishes an original website and affiliates establish websites below. Each affiliate provides a link to the website on the up-line. The linked websites are protected/managed by application of re-encryption technology and the number of viewers who have visited the websites and the frequency of viewing are accurately calculated to facilitate payment of secondary-use copyright royalties to secondary-users who process content as well as payment of copyright royalties to original authors.

### TECHNICAL FIELD

The present invention relates to a Content Management System in website linkage formed on the Internet.

### BACKGROUND ART

It has been broadly practiced to connect a website by means of links with others' websites, in anticipation of an effect to increase the traffic on the own website by calling viewers of others' websites. Examples of similar systems involving re-encryption technology can be found in U.S. Pat. Nos. 6,272,635, 6,182,218, 6,128,605, 6,097,818, 6,097,816, 6,081,794, 6,076,077, 6,069,952, 6,002,772, 5,974,141, 5,901,339, 5,867,579, 5,848,158, 5,794,115, 5,740,246, 5,646,999, 5,504,933, 6,141,753, 5,818,933. However, a business model that put such a benefit into an economic profit and distributes it to each website according to their respective rating of contribution has never been developed yet.

### DISCLOSURE OF THE INVENTION

The present invention is about a system, wherein a series of websites connected via links is formed as a kind of Websites-Linked Intranet on the Internet, and whereby the revenue which the whole Websites-Linked Intranet earned viewing fee, advertisement income etc. as sources are properly distributed to masters of websites according to their respective rating of contribution calculated by the number of visitors, frequency of views etc. to their websites.

To enable the above concept, the present invention employs re-encryption technology.

Protection by re-encryption technology over the whole Websites-Linked Intranet not only shuts out unauthorized accesses by third parties but also prevents any attempt by once-authorized viewers to make unauthorized copy of content or re-access the website by memorizing URL of the website the viewer has visited earlier.

In addition, since the present invention enables to return to a secondary-user of content a fair share of its contribution, it is possible for an ordinary viewer to participate in the Websites-Linked Intranet to improve on content and to earn a royalty of secondary-use copyright.

As a result the Websites-Linked Intranet, with self-propagating added values, generates a tremendous economic profit.

### BRIEF DESCRIPTION OF THE DRAWINGS

FIG. 1 is a schematic diagram of the Websites-Linked Intranet.

FIG. 2 is a schematic diagram illustrating a process for handling original copyrights by re-encryption technology.

FIG. 3 is a schematic diagram illustrating a process for handling a secondary-use copyright by re-encryption technology.

L (xy-zw) indicates a link connecting website xy with website zw.

Ka: The “a-th” encryption key (common key) in sequential order of generation.

Ka/Kb: Ka is a decryption key (common key) and Kb is a re-encryption key (common key).

Cij(Kc) indicates a content that creator ij encoded by the encryption key Kc.

Smn(Kd) indicates a processing scenario encrypted by creator mn by the encryption key Kd.

### BEST MODE FOR CARRYING OUT THE INVENTION

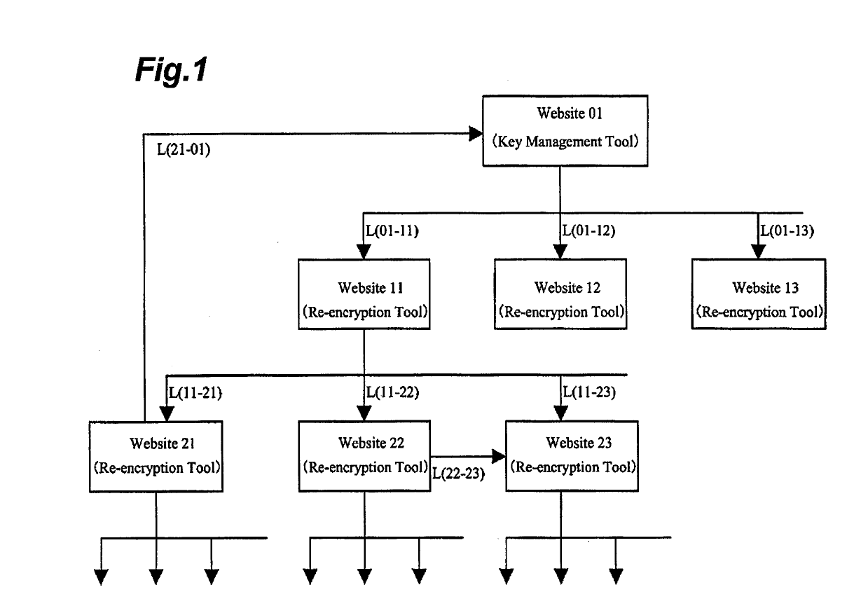

This invention shall be described in detail with reference to FIG. 1.

First, a founder of a Websites-Linked Intranet establishes an original website01.

In order to manage the Websites-Linked Intranet, the founder sets up a key management server and installs a key management tool thereon.

The key management tool is composed of a key management program, a fee collection program and a CGI program, etc.

Affiliates to the Intranet establish their websites and will conclude contracts to be admitted a right to connect their websites to the original website01 by means of links.

Primary affiliates establish websites 11, 12, 13 . . . .

Primary affiliates will, then, install re-encryption tools on their terminals. A re-encryption tool is composed of a control program for receiving and transmission of cipher keys, a control program for decryption and re-encryption, etc.

While each website is to be established by an independent affiliate in principle, a plurality of websites may be established by a same person (or corporation).

Primary affiliates will connect each one of their websites 11, 12, 13 . . . via links L (01-11), L (01-12), L (01-13) . . . to the founder's original website 01, respectively.

Similarly, secondary affiliates will establish their websites 21, 22, 23 . . . on the primary affiliates' down-line, and connect their websites via links L (11-21), L (11-22), L (11-23) . . . .

In the same manner, new affiliates will join one after another on the down-lines to establish their websites and connect them with the websites on the up-line via links respectively. As a result, a series of websites propagates in a tree shape.

However, such links may not necessarily be uniformly stretched to down-line websites, and may, instead, be skipping a upper level website and immediately returns to the original website 01 as shown in the case of L (21-01), or may be directed to websites on the same level as shown in the case of L (22-23). Links may also be stretched mutually providing connection among websites.

In order to systematize a series of websites formed as mentioned above as a Websites-Linked Intranet and to protect interests of all affiliates centering on the founder, the present invention employs re-encryption technology.

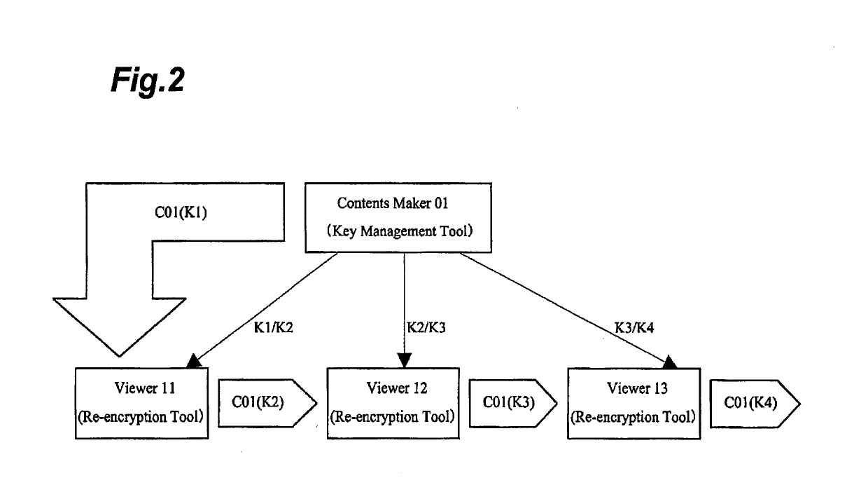

The mechanism of the system shall hereinafter be described with reference to FIG. 2.

The following process is automatically controlled instantaneously without any loads on viewers.

Further, since all history of demands for keys transmitted from viewer terminals to the key management server are recorded, a post audit can be carried out in case of an unfair practice.

First, a content maker 01 encrypts a content C01 with an encryption key K1 (common key) and uploads it as C01(K1), and then deposits K1 into a key management server.

Next, when a viewer 11 downloads the content C01(K1) and demands K1 from the key management server for decryption thereof, the key management tool charges a viewer fee in exchange of downloading of the cipher key(decryption key) K1.

The moment when the viewer 11 decrypts C01(K1) by K1 to view, C01 will be re-encrypted by K2 and will turn into C01(K2).

Thereafter, C01 will similarly be re-encrypted into C01(K3) and C01(K4) by K3 and K4 respectively.

Therefore, the Websites-Linked Intranet protected by re-encryption technology not only shuts out unauthorized accesses by third parties but also prevents any attempt by once-authorized viewers to commit such unfair practices as mentioned below:
To make unauthorized copy of the content which the viewer viewed legitimately earlier. Such practice is impossible because the content has been immediately re-encrypted after view.
To make unauthorized access to the Websites-Linked Intranet which the viewer accessed earlier legitimately. This is also impossible because a re-encryption key has been replaced by a new one each time.
To trespass upon a website of the Websites-Linked Intranet by memorizing the URL of the website to which the viewer accessed earlier legitimately. This practice is impossible because the key is under control of founder's key management server.

Such being the structure of the system, the history of key demand from a viewer recorded on the founder's key management server can also be a reliable source of an accurate record of the viewer's viewing behavior.

According to these data, the founder computes the number of visitors to each website, frequency of views, etc. for assessment of their respective rating of contribution.

### INDUSTRIAL APPLICABILITY

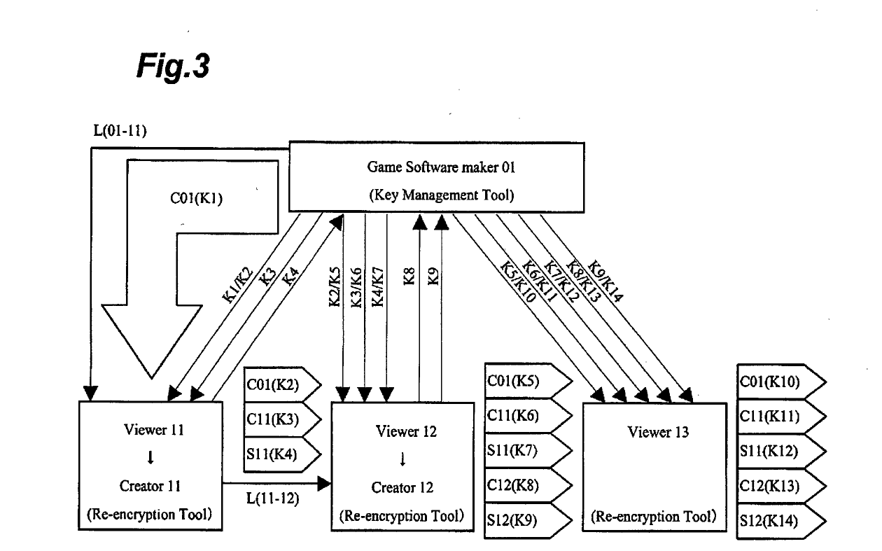

An embodiment of practice of the present invention shall be described with reference to FIG. 3, wherein “divergent-collaboration” type role-playing game (RPG)” is illustrated as an example.

First, a founder, namely a game software maker 01, creates an original story C01 and uploads it.

A space for links should be provided for to allow viewers' participation on a turning scene (where the story branches and develops) of the game.

A viewer 11 decrypts the original story C01(K1) by K1 and enjoys it.

While the viewer 11 may simply enjoy a given RPG, he can also participate as a creator 11 to create his own alternative story (which is branching and developing from the original story).

In this case, the creator 11, after concluding a contract with the content maker 01 to register his own website, acquires a right to connect his own website with the content maker 01's website via a link, and installs a re-encryption tool.

The creator 11 will connect the alternative story created on his/her own via a link L (01-11) with the turning scene of the original story C01 which the game software maker 01 created.

The creator may process those characters and items which appeared in the original story as materials, and may adopt them into components of his/her own alternative story.

In the above-mentioned case, the present invention employs re-encryption technology so that the process for handling copyrights may be executed fairly and smoothly, too.

The mechanism of the process for handling a secondary-use copyright by re-encryption technology shall be described below.

First, a content maker 01 uploads an encrypted content C01(K1).

A viewer 11 becomes a creator 11 to create his/her own contents.

The creator 11 downloads K1 from the key management server and decrypts C01 (K1) in order to make secondary-use of C01.

At this moment, a royalty is paid to the content maker 01 by the creator 11.

The creator 11, using the content C01 as a material, compounds/processes it with the content C11 which he/she created on his/her own into a secondary content with a higher added value.

The process of this composing/processing is filed as a processing scenario S11.

The creator 11, recognizing C11 as his/her original content and S11 as secondary content maid by him/her, encrypts each of them by K3 and K4 respectively, and uploads them as C11(K3) and S11(K4).

Next, a mechanism of the process for handling a secondary-use copyright shall be described by way of an example, wherein a second viewer 12, connecting his/her website via the link L (11-12) with the alternative story which the creator 11 created, becomes a second creator 12 to create his/her alternative story on his/her own.

The second creator 12 downloads K4 in order to make secondary-use of S11(K4) as a material.

At this moment, a royalty is paid by the second creator 12 to the creator 11.

When S11(K4) gets decrypted, the processing scenario S11 starts to download K2 and K3 automatically.

At this moment, royalties are paid to the content maker 01 and to the creator 11.

S11 re-compounds C01 and C11 automatically.

Second creator 12, making secondary-use of the above-mentioned re-compounded content as a material, compounds/possesses it with C12 which he/she created on his/her own, and makes the process file as a processing scenario S12.

Second creator 12, recognizing C12 as his/her original content and S12 as secondary content maid by him/her, encrypts each of them by K8 and K9 respectively, and uploads them.

When a third viewer 13 decrypts S12(K9), S12 starts to download K7 and K8 automatically.

At the above-mentioned moment, a royalty on C12 is paid by the third viewer 13 to the second creator 12 and part of the royalty is further paid to the creator 11 as a charge of secondary-use of S11.

When S11(K7) gets decrypted, S11 starts to download K5 and K6 automatically.

At the above-mentioned moment, part of the royalty which the second creator 12 received from the third viewer 13 is paid to the game software maker 01 and the creator 11 as charges of secondary-use of C01 and C11, respectively.

The process for handling the secondary-use copyrights employing re-encryption technology is based on such a mechanism, therefore, even if part of content is cut off and is made secondary-use of by others, the child-parent relationship of copyrights is inherited and the original author's right will never be infringed.

Moreover, such a chained relationship continuing infinitely, any right of a secondary-user in the middle will never be infringed.

Thus, the structure, wherein not only an original author's right but also all the infinitely-chained secondary authors' rights are protected, getting new creators to join one after another, just like children and grandchildren are born from a pair of parents, will form RPG software with a huge tree-shaped branches. (It may not necessarily be a uniformly structured-tree flowing from upper to the lower levels, but a more flexible one enabling more complicated development of a story including loops and warps.)

In addition, it will be a living RPG which does not stop propagating itself every day, and become to be a very profound RPG that even a game software maker who planned the first creation of an original story can not have a prevision of it.

For a viewer, it is RPG in which an uncertain strange drama is awaiting every day, and is a new product which never be bored.

A benefit of the Websites-Linked Intranet resides in the market multiplication process by profits guidance peculiar to the Multi-Level Marketing (MLM). In the same way that customers in a MLM system become sales-promoters themselves to open new markets, viewers in the content management system of the Websites-Linked Intranet become creators themselves to expand networks, too. Besides, unlike a so-called MLM, the effect is synergistic because a product (=content) diversifies its variety.

In the present invention, wherein allowable secondary-use of content is encouraged, unlike simple diversification of content, value added to constituent content itself is also increasing.

Such effect arises because creators do not simply compete with each other in the creating content of their own independently but they create content with their more originality and creativity building upon the content which others created.

Moreover, in the present invention, since actual collection of the charge of secondary-use is secured, added value is realized as economic profit.

That is, upon sales of a content created by a secondary-user, a royalty will be returned to the original author, also, whose content have been used by the secondary-user as a material thereof.

The Websites-Linked Intranet, because of its nature of handling intangible properties, has a comparative advantage over so-called MLM by eliminating physical distribution of products.

Since content are all transacted instantaneously on a network, variable costs concerning their distribution can be approximated to almost zero.

Further, with minimum incremental capital investment and business expenses, marginal costs can be decreased geometrically.

Another side effect of the present invention is a function of recruiting new creators. Since the Websites-Linked Intranet is opened to viewers, it is expected that a lot of would-be creators full of talents will be produced out of many viewers in the general public.

1. A content management system, wherein a series of websites connected via links is formed, whereby revenues can be distributed by a founder who established the uppermost website to masters of lower level websites according to their respective rating records.

2. A content management system as set forth in claim 1, wherein a series of websites is protected by re-encryption technology against losses by unfair practices and/or unfair profits etc. caused by viewers and/or website masters etc.

3. A content management system as set forth in claim 1, wherein a series of websites is protected by re-encryption technology, wherein the system is so designed to facilitate payment of secondary-use copyright royalties to secondary-users who process content as well as payment of copyright royalties to original authors.

4. A content management system comprising:
a top website;
a lower website linked to the top website;
a founder establishing the top website and mastering the lower website; and
royalties, distributed by the founder to the lower website based on a rating record of the lower website.

5. A content management system of claim 4, further comprising re-encryption technology protecting the top and lower website.

6. A content management system of claim 4, further comprising:
content disposed on the top and lower websites;
secondary-users who process the content;
a system to process copyright royalties from the secondary-users; and
a system to pay content authors the copyright royalties.

7. A method to manage content on linked websites, comprising the steps of:
connecting a top website to a lower website;
recording data from the lower website;
determining a rating record based on the data; and
distributing revenues to the lower website based on the rating record.

8. The method of claim 7, further comprising the step of protecting the top and lower website using re-encryption technology.

9. The method of claim 7, further comprising the steps of:
protecting the top and lower website using re-encryption technology;
processing a payment of copyright royalties by secondary users of a content on one of the top and the lower website; and
paying the copyright royalties to an author of the content.
